(19) United States
(12) Patent Application Publication
(10) Pub. No.: US 2012/0097722 A1
(43) Pub. Date: Apr. 26, 2012

(54) RAIL-MOUNTED MODULAR STORAGE SYSTEM FOR A BICYCLE

(76) Inventor: Joshua Kahan, Hanover, NH (US)

(21) Appl. No.: 12/908,956

(22) Filed: Oct. 21, 2010

(51) Int. Cl. B62J 11/00; B23P 17/04

(52) U.S. Cl. 224/414; 29/428

(57) ABSTRACT

A modular storage system for use with a bicycle can include a rail coupled to the top tube of the bicycle and at least two rigid compartments or modules releasably coupled to the rail. Each of the rigid compartments has an interior compartment accessible while a rider is riding the bicycle. Each of the rigid compartments can be shaped to have low aerodynamic drag. Each rigid compartment can be configured to hold at least one of a fluid container, food, bicycle repair implements, a replacement tube, and a replacement tire.

### FIELD

This application relates generally to accessories for bicycles and in particular, to storage systems for items carried on a bicycle.

### BACKGROUND

Bicycles are used for transportation, exercise, competition, and recreation by many millions of people around the world. Around 20 million bicycles are sold each year in the United States alone. Because bicycles are very good at transporting people great distances, it is easy to travel far from civilization and potential help. Some people, particularly those training for competition, can ride up to 100 miles or more in a single day. In riding such distances, riders will need water and food, and often carry spare parts and tools because they can be required to repair a damaged tire or tube to avoid being stranded far from help and needing to wait a significant amount of time for help to arrive or to walk the bicycle to a safe place.

Many devices have been made to aid in carrying water and other useful things that one can want or need when bicycling far from help, such as tools, replacement tires and tubes, etc. However, each of these devices is very specific for the particular item it is supposed to carry, and are generally not convenient to access when riding. Bicycle riders, especially racers or those training to race, often have different requirements on different days for carrying items. For example, a racer can want water, food, and a spare tube when training long distances, and only tools and a spare tire when racing as food and water are available along the race route.

Each existing device for carrying a particular item, such as tools or food, tend to be mounted to the bicycle in a very particular manner, requiring significant effort to add or remove the device and mounting hardware, making it difficult to change the configuration of items to be carried for any particular day of riding. Similarly, bicycle racers tend to not use these devices because they generally create additional unwanted aerodynamic drag.

### SUMMARY

Embodiments of a modular storage system for use with a bicycle are discussed and illustrated that can be used to quickly and easily attach items needed by a cyclist. Embodiments include a rail coupled to the top tube of a bicycle and at least two rigid compartments or modules releasably coupled to the rail. Each of the rigid compartments can have an interior accessible when riding the bicycle. Similarly, each of the rigid compartments can be shaped to have low aerodynamic drag. Each rigid compartment can be configured to hold at least one of a fluid container, food, bicycle repair implements, a replacement tube, and a replacement tire.

In some embodiments, the modular storage system can include a third rigid compartment releasably coupled to the rail. One or more components of the modular storage system can be substantially formed from carbon fiber, HDPE, or a combination of the two, or from other rigid, lightweight materials such as aluminum.

In some modules, the interior can be accessible through a hinged opening. In other modules, the interior can be accessible by removing a top portion of the rigid compartment. And in others, the interior can be accessible through a sliding door opening. The bicycle can be any type of bicycle, including a racing bicycle.

An individual having a bicycle with the modular storage system can select different modules as desired for a particular day of riding. For example, the individual can select at least two modules from modules each containing at least one of food, water, bicycle repair tools, spare inner tube, spare tire, and personal accessories. The modules can then be attached to a rail coupled to a top bar of a bicycle. During the ride, the individual can access the interior of at least one of the selected modules without the need to stop.

### BRIEF DESCRIPTION OF THE DRAWINGS

The following description can be better understood in light of Figures, in which:

FIG. 1 is an illustration of an exemplary embodiment of a modular storage system for bicycles with a food storage module;

FIG. 2 is an illustration of the modular storage system of FIG. 1 with a cover in an open position;

FIG. 3 is an illustration of an exemplary embodiment of a modular storage system for bicycles with a tire storage module;

FIG. 4 is an illustration of the modular storage system of FIG. 3 with a cover in a closed position;

FIG. 5 is an illustration of a rail for a modular storage system for bicycles.

FIG. 6 is an illustration of an embodiment of a modular storage system for bicycles with two modules, one with an open cover;

FIG. 7 is an illustration of an exemplary embodiment of a water storage module for a modular storage system for bicycles;

FIG. 8 is an illustration of an exemplary embodiment of a tire/tube storage module for a modular storage system for bicycles; and

FIG. 9 is an illustration of an exemplary embodiment of a modular storage system for bicycles with three modules, including a module with a sliding cover.

Together with the following description, the Figures demonstrate and explain the principles of inventive modular storage systems for bicycles and methods for using and making the systems. In the Figures, the thickness and configuration of components can be exaggerated for clarity. The same reference numerals in different Figures represent the same component.

### DETAILED DESCRIPTION

The following description supplies specific details in order to provide a thorough understanding. Nevertheless, the skilled artisan would understand that embodiments of modular storage systems for bicycles and associated methods of using the systems can be implemented and used without employing these specific details. Indeed, exemplary embodiments and associated methods can be placed into practice by modifying the illustrated units and associated methods and can be used in conjunction with any other devices and techniques conventionally used in the industry. For example, while the description below focuses generally on a rail with detent positioning, any type of connection to a fixed rail can be used to easily change different modules as desired.

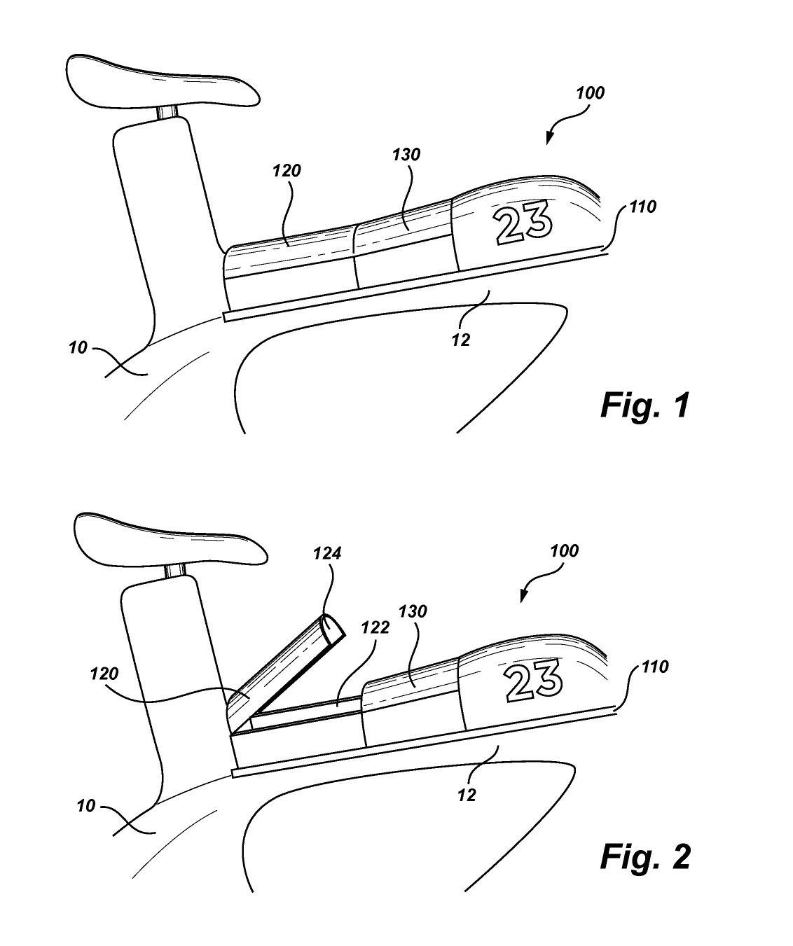

One exemplary modular storage system for use with bicycles is illustrated in FIGS. 1-3. In the Figures, modular storage system 100 is shown. Modular storage system 100 can be mounted to top bar 12 of bicycle 10. Modular storage system 100 includes mounting rail 110 with two different modules coupled to mounting rail 110, including food module 120 releasably coupled to rail 110, and tube and tool module 130 coupled to mounting rail 110.

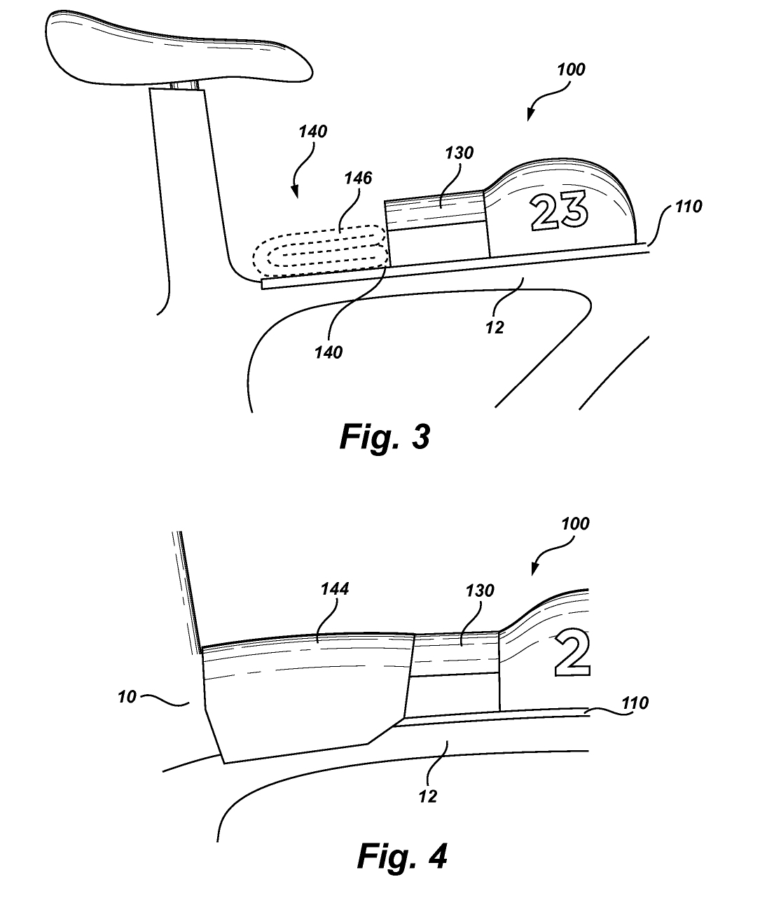

Different modules can be releasably coupled to mounting rail 110 as desired. For example, in FIGS. 3-4, replacement tire module 140 is in place of food module 120 shown in FIGS. 1-2. In some embodiments, each of the modules can be designed to be aerodynamically efficient, incorporating a door or cover to provide smooth air-flow over an otherwise aerodynamically inefficient shape, such as with replacement tire 246 in FIG. 4.

The various modules can be rigid to hold the desired storage items to mounting rail 110. Each of the components of modular storage system can be made of a rigid material, taking weight into consideration, such as carbon fiber, high density polyethylene (HDPE), or any other suitable material. Similarly, the various modules can have different types of covers or access configurations, depending on the desired use. For example, food module 120 of FIGS. 1-2 is shown having hinged opening for cover 124 to allow access to the contents of module 120 by a rider while bicycle 10 is in motion, while replacement tire module 140 has removable rigid cover 144 more suited to tire repairs that necessarily cannot be performed while bicycle 10 is moving. Other embodiments can have a sliding cover.

Each module includes a rigid base to removably connect with mounting rail 110. For example, food module 120 includes rigid base 122 and replacement tire module 140 includes rigid base 142 holding replacement tire 146, as shown in FIG. 3. Mounting rail 110 allows for a rider to select a desired module for a particular day and quickly and easily attach at least two desired modules to mounting rail 110 for a ride. For example, a racer can select a tool and tire module and a food module for race day when water is readily available throughout the course, while another bicyclist can select a food module and a water module for a leisurely afternoon ride. Any combination of modules for any desired purpose is possible.

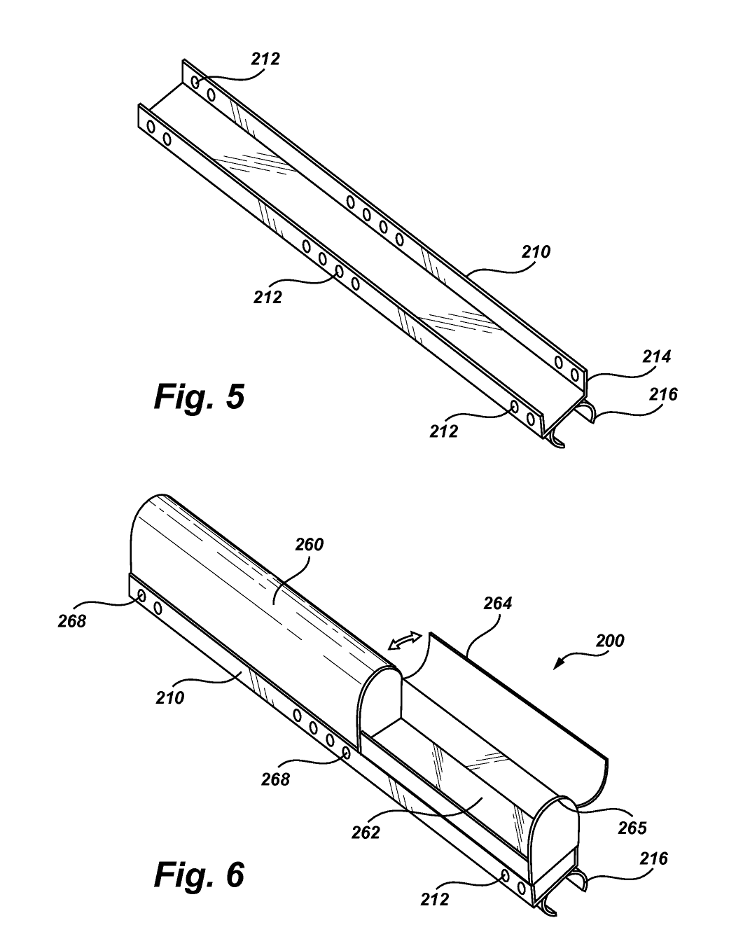

An exemplary embodiment of a mounting rail is shown in particular detail in FIG. 5 as mounting rail 210. Mounting rail 210 can be a horizontal plate with vertical members 214 and bicycle mounting flanges 216. Vertical members 214 can includes mounting holes 212 to allow for the selectively releasable mounting of the various modules, as will be described in more detail below. Bicycle mounting flanges 216 can be any design that allows mounting rail 210 to be coupled to top bar 12 of bicycle 10. For example, flanges 216 can have holes that correspond to holes in top bar 12 to allow screws or bolts to secure rail 210 to top bar 12. Similarly, mounting rail 210 can be held to top bar 12 with straps that pass under top bar 12.

Any conventional mounting systems for mounting components to bicycles can be used to couple mounting rail 110, 210, 310 or any other embodiment of a mounting rail, to bicycle 10. Similarly, mounting rail 110, 210, 310 can be configured to be mounted to both round tube and other types of top tube 12 profiles as different bicycle manufacturers have designed top tube 12 with various profiles for strength and performance.

Various exemplary embodiments of modules are shown in FIGS. 6-10. Turing now to FIG. 6, a pair of general modules 260 are shown attached to mounting rail 210. General module 260 can hold food, water, glasses, etc. General module 260 is illustrated as attached with detents 268 extending through holes 212 to provide a selectively releasable attachment to mounting rail 210. In addition to the detent-type arrangement illustrated, other types of fastening arrangements for selectively attaching a module to a mounting rail can be employed. For example, the mounting rail can include a flat plate that lies above top bar 12. The flat plate can have holes that correspond to protrusions from the bottom of a module that allows the module to snap into place on the mounting rail. Of course, any number of different mounting arrangements will be known to one of ordinary skill. Any module can be placed on rail 210 along with any other module.

Detents 268 can be located in rigid body 262 such that when detents 268 are depressed, rigid body 262 can be placed between vertical members 214 of mounting rail 210. Once detents 268 are lined up with corresponding holes 212, detents 268 then extend through holes 212, securing each general module 260 to mounting rail 210. Each general module 260 can be removed from mounting rail 210 by pressing detents 268 and lifting rigid body 262 away from mounting rail 210.

General module 260 includes door 264 that opens with hinge 265. Hinge 265 can be a barrel hinge or any other type of hinge. Door 264 can provide access to the interior of module 260 while a person riding a bicycle is in motion. Door 264 can be held shut with magnets, clips, corresponding snap features, or any other fasteners or holding devices to allow one-handed, easy access for a person operating a bicycle, preferably without having to look.

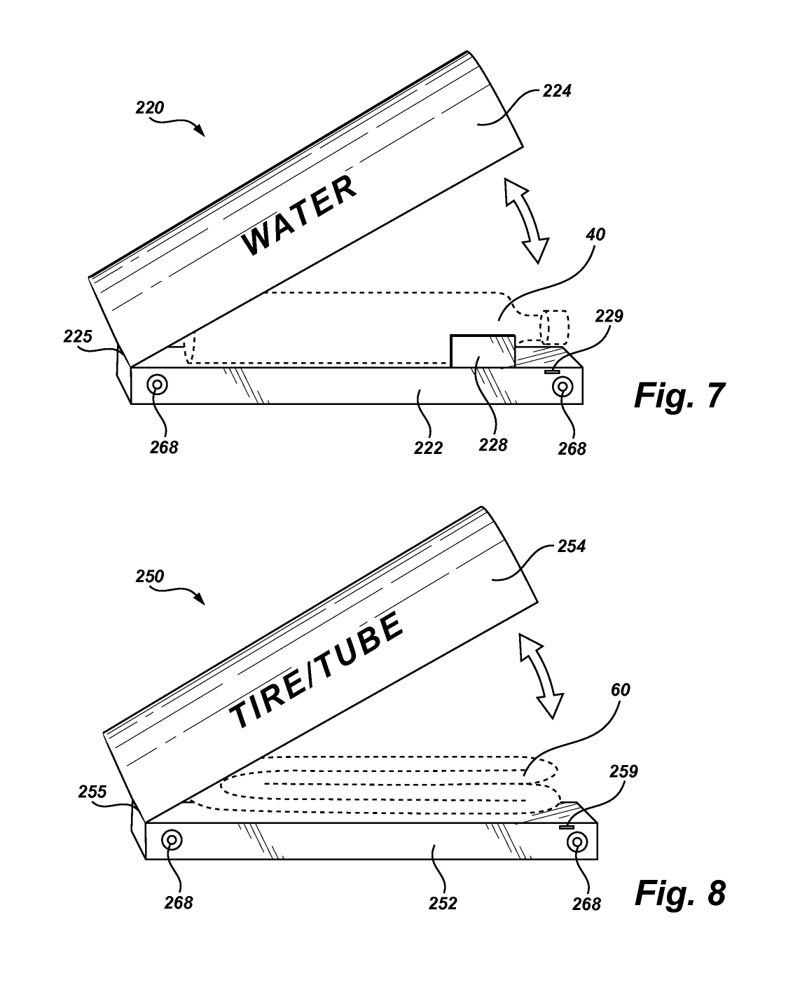

FIGS. 7 and 8 illustrate similar modules, water module 220 and tire/tube module 250. Water module 220 includes rigid base 222 with door 224 attached to rigid base 222 with hinge 225. Hinge 225 allows a user to easily lift door 224 while riding and access a water bottle 40 held in rigid base 222 with flanges 228. As illustrated, water module 220 includes detents 268 for attaching to mounting rail 210. Water module 220 can also include snap protrusions 229 and corresponding features on door 224 to allow door 224 to be held in place during normal riding.

Similar to the illustrated embodiment of FIG. 7, FIG. 8 illustrates tire/tube module 250 with door 254 attached to rigid base 252 through hinge 255. Door 254 can cover replacement tire 60, or a replacement tube, and can also include tools or other items used to repair or replace a punctured tire or tube. Tire/tube module 250 can also include snap protrusions 259 to hold door 254 in place during riding. In some embodiments, snap protrusions 259 can include magnets with corresponding magnetic material in cover 254. Similarly, snaps or other types of fasteners can be used to hold door 254, or any other cover or door of any module, in place during operation of the bicycle.

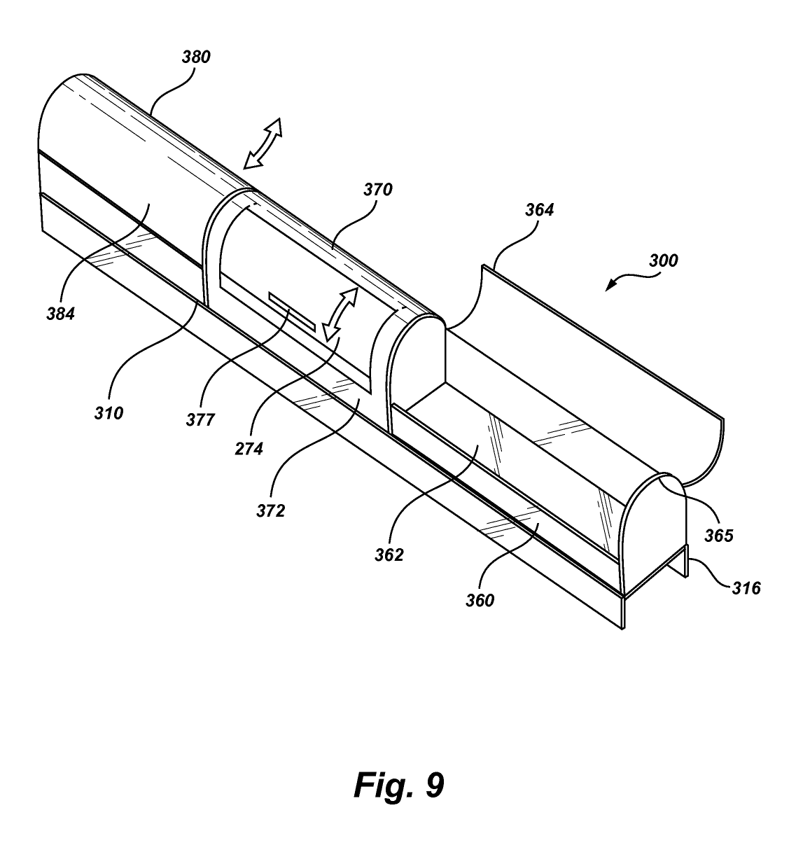

FIG. 9 illustrates modular storage system 300 with general module 360, sliding door module 370, and hinged cover module 380 releasably attached to mounting rail 310. Mounting rail 310 includes bicycle mounting flanges 316, similar to mounting rail 110, 210 described above. General module 360 is similar to general module 260 described above, with door 364 attached to body 362 through hinge 365. Sliding door module 370 includes door 374 in rigid body 372. Door 374 can be opened by pushing against ridge 377 to force door 374 to slide, revealing the interior of module 370. Module 380 includes a hinged cover 384 that opens to reveal the interior, similar to the modules shown in FIGS. 7 and 8.

In addition to any previously indicated modification, numerous other variations and alternative arrangements can be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use can be made without departing from the principles and concepts set forth herein. Also, as used herein, examples are meant to be illustrative only and should not be construed to be limiting in any manner.

What is claimed is:

1. A modular storage system for bicycles, the modular storage system comprising:
a rail configured to be coupled to the top tube of a bicycle;
a first rigid compartment configured to be releasably coupled to the rail; and
a second rigid compartment configured to be releasably coupled to the rail,
each of the first and second rigid compartments having an interior storage space that can be accessed while a rider is riding the bicycle.

2. The modular storage system of claim 1, wherein each of the first and second rigid compartments are shaped to have low aerodynamic drag.

3. The modular storage system of claim 1, wherein each rigid compartment is configured to hold at least one of:
a fluid container; food; bicycle repair implements; a replacement tire; a replacement tube.

4. The modular storage system of claim 1, further comprising a third rigid compartment releasably coupled to the rail.

5. The modular storage system of claim 1, wherein the first and second rigid compartments are substantially formed from carbon fiber.

6. The modular storage system of claim 1, wherein the first and second rigid compartments are substantially formed from HDPE.

7. The modular storage system of claim 1, wherein the interior of the first rigid compartment is accessible through a hinged opening.

8. The modular storage system of claim 1, wherein the interior of the first rigid compartment is accessible by removing a top portion of the rigid compartment.

9. The modular storage system of claim 1, wherein the interior of the first rigid compartment is accessible through a sliding door opening.

10. The modular storage system of claim 1, wherein the bicycle is a racing bicycle.

11. A method for attaching storage modules to a bicycle, the method comprising:
selecting at least two modules from modules each containing at least one of food, water, bicycle repair tools, spare inner tube, spare tire, and personal accessories;
attaching the selected modules to a rail coupled to a top bar of a bicycle; and
accessing the interior of at least one of the selected modules while operating the bicycle.

12. The method of claim 11, wherein each of the modules includes a rigid compartment.

13. The method of claim 11, wherein each of the modules is shaped for low aerodynamic drag.

14. The method of claim 11, wherein the modules are substantially formed from HDPE.

15. The method of claim 11, wherein the interior of at least one of the selected modules is accessible through a hinged opening.

16. The method of claim 11, wherein the interior of the at least one of the selected modules is accessible by removing a top portion of the module.
